(19) United States
(12) Patent Application Publication
(10) Pub. No.: US 2009/0301315 A1
(43) Pub. Date: Dec. 10, 2009

(54) Microwave Food Stabilizing Device

(76) Inventor: Don Brown, Laguna Niguel, CA (US)

Correspondence Address: QUICKPATENTS, INC., 32861 CALLE PERFECTO, SUITE A, SAN JUAN CAPISTRANO, CA, 92675, US

(21) Appl. No.: 12/134,034

(22) Filed: Jun. 5, 2008

(51) Int. Cl. A47J 43/18; B65D 51/00; H05B 6/80

(52) U.S. Cl. 99/427; 220/377; 219/732; 219/734

(57) ABSTRACT

The present device is an apparatus for stabilizing food items, such as marshmallows, desserts, crackers, or the like, on a horizontal surface while cooking. The apparatus includes a base for supporting the food item. The device further includes an enclosure for selectively attaching with the base for covering the food item, and which has a top aperture therethrough. The invention further includes a stabilizing arm that is slidably connected through the top aperture of the enclosure. The stabilizing arm may be moved between a raised position and a lowered position to stabilize the food item on the base when cooking, such as in a microwave oven.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to cooking tools, and more particularly to a device for stabilizing food while cooking.

### DISCUSSION OF RELATED ART

Certain food items, such as so-called “S'mores” made with marshmallows, graham crackers, and chocolate, have a tendency to fall-over when cooking in a microwave on a plate, for example. This is a result of the marshmallow expanding while being cooked in a microwave, and then collapsing when reaching a certain temperature. Traditionally, when cooking marshmallows over an open campfire on a skewer, for example, food stability is not a problem, except for the occasional marshmallow falling into the campfire. However, when making S'mores at home in a microwave, food stability becomes an issues.

One prior art device, taught in U.S. Pat. No. 5,749,286 to Payette on May 30, 1995 discloses a fondue cooking apparatus for stabilizing food item comprising a number of holding elements for holding food items, has a complicated design and not at all user friendly. Such a device is not suited for use in a microwave or with the components of S'mores.

Another prior art device, taught in U.S. Pat. No. 3,038,402 to Thomas on Nov. 5, 1972 discloses a cooking device comprising a cover dish having an opening therein to permit the placing of an edible object carried by a utensil within a dish. Such a device has a plurality of utensil receiving slots. Such a device is also not suited for stabilizing food items in a microwave oven in that it is made of metal, which is unsafe in a microwave and further has the drawback of being relatively expensive to manufacture.

Therefore, there is a need for a food stabilizing device that is less complicated than prior art devices, is microwave-safe, and is easy to use and clean. The present invention accomplishes these objectives.

### SUMMARY OF THE INVENTION

The present device is an apparatus for stabilizing food items, such as marshmallows, desserts, crackers, or the like, on a horizontal surface while cooking. The apparatus includes a microwave-inert base for supporting the food item and an enclosure for selectively attaching with the base for covering the food item. The enclosure further includes a top aperture therethrough and a stabilizing arm that is slidably connected through the top aperture of the enclosure. The stabilizing arm may be moved between a raised position and a lowered position.

The present invention is a food stabilizing device that is less complicated than prior art devices, is microwave-safe, and is easy to use and clean. The present device works particularly well for stabilizing food that moves while cooking, due to heat. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view of the invention, illustrating a base, an enclosure and a stabilizing arm of the invention;

FIG. 2 is a front elevational view of the invention, illustrating the stabilizing arm in a raised position;

FIG. 3 is an exploded rear elevational view of the invention, illustrating the stabilizing arm in a lowered position and the enclosure as removed from the base;

FIG. 4 is a right side elevational view of the invention, the left-side elevational view being a mirror image thereof,

FIG. 5 is a top plan view of the invention, illustrating a knob of the invention; and

FIG. 6 is a bottom plan view of the invention.

### DETAILED DESCRIPTION OF THE PREFERRED EMBODIMENT

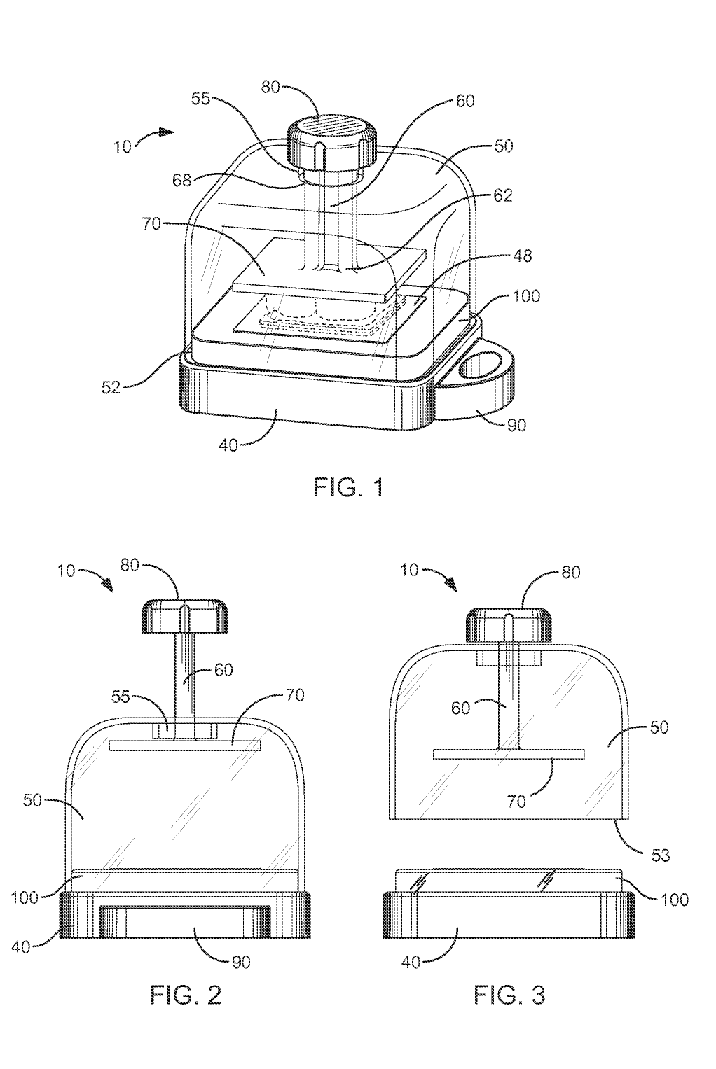

FIGS. 1 and 2 illustrate an apparatus 10 for stabilizing a food item 20, such as marshmallows, desserts, crackers, or the like, on a horizontal surface 30 while cooking. The apparatus 10 includes a base 40 for support the food item 20. The base 40 may be molded from a microwave-safe plastic material or wood material, for example. In one embodiment the base 40 is made from an opaque material. However, in an alternate embodiment, the base is made from a transparent material (not shown).The base 40 further includes a laterally-projecting handle 90 and a substantially horizontal platform surface 48 with a retention means 46 proximate a peripheral edge 45 thereof The handle 90 projects away from the base 40 where it is less apt to become heated in a microwave through convection from the heated food item 20.

An enclosure 50 is further included that is selectively attachable with the base 40 for covering the food item 20. The enclosure 50 further includes a top aperture 55 there through. Preferably the enclosure 50 is made from a transparent microwave-safe plastic material. Ideally the enclosure 50 and the base 40 are rectangular in shape, although any suitable shape in plan view could be used. The enclosure 50 is selectively attachable with the base 40 at an open lower end 62 of the enclosure 50 forming a friction fit around a perimeter of a lip 100 of the base 40. The open lower end 52 of the enclosure has a peripheral edge 53 adapted to engage the enclosure retention means of the base 40 (FIG. 3).

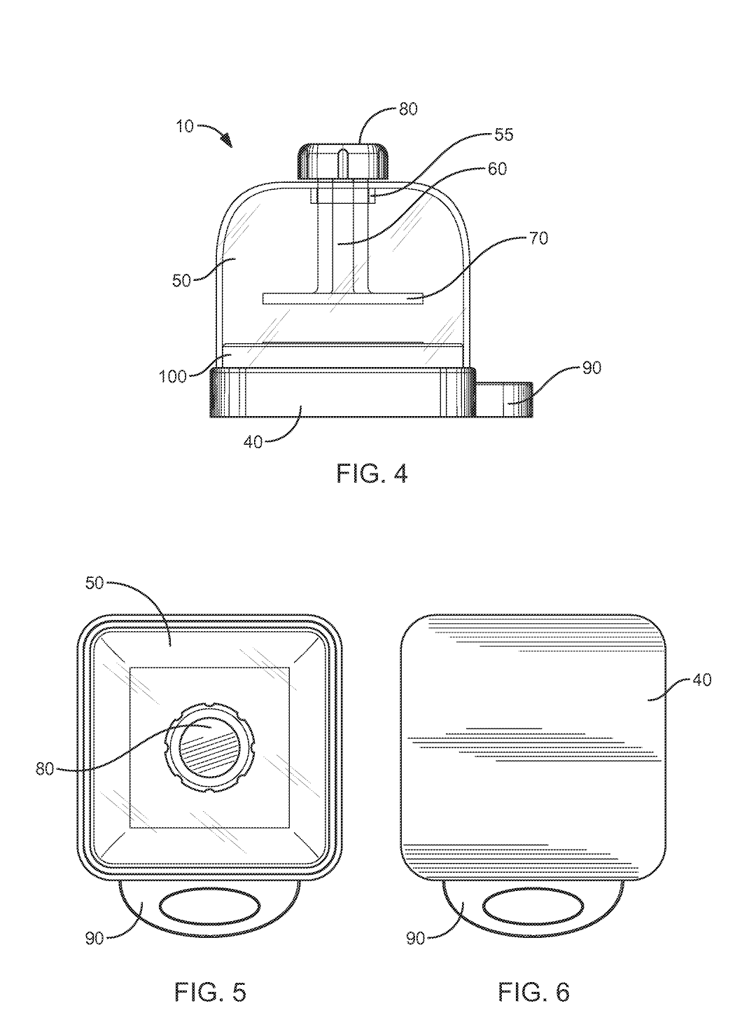

The invention further includes a stabilizing arm 60 that is slidably connected through the top aperture 55 of the enclosure 50 (FIGS. 1, 3 and 4). In one embodiment of the invention, the stabilizing arm 60 includes an enlarged foot 70 at a lower end 62 of the stabilizing arm 60. As such, the food item 20 may be pressed against the base 40 if desired, between the foot 70 and the base 40. The stabilizing arm 60 may be moved between a raised position (FIG. 2) and a lowered position (FIGS. 1 and 3).

In the preferred embodiment of the invention, the aperture 55 of the enclosure 50 is non-circular. The stabilizing arm 60 has the same shape in cross-section as the aperture 55 of the enclosure 50 so that the stabilizing arm 60 cannot rotate when capture by the aperture 55 of the enclosure 50. Further, a knob 80 may be included a the top end 68 of the stabilizing arm 60 for facilitating the manual movement of the stabilizing arm 60. Further, since both the knob 80 and the enlarged foot 70 of the stabilizing arm 60 are larger than the aperture 55 of the enclosure 50, the stabilizing arm 60 is slidably captured by the enclosure 50. The base 40, the enclosure 50 and the stabilizing arm 60 are made from microwave-safe plastic material.

In use, the food item 20 is rested on the base 40 and the enclosure 50 is attached with the base 40. The stabilizing arm 60 rests on the food item 20 by gravity to stabilize the food item 20 while cooking, such as in a microwave. As the food item 20 expands, the stabilizing arm 60 rises up with the food item 20, maintaining the food item 20 on the base 40.

While a particular form of the invention has been illustrated and described, it will be apparent that various modifications can be made without departing from the spirit and scope of the invention. For example, the base 40 and the enclosure 30 may be circular in shape. Accordingly, it is not intended that the invention be limited, except as by the appended claims.

What is claimed is:

1. An apparatus for stabilizing a food item on a horizontal surface while cooking, comprising:
a base for supporting the food item;
an enclosure selectively attachable with the base for covering the food item; and
a stabilizing arm slidably connected through a top aperture in the enclosure;
Whereby with the food item resting on the base and the enclosure attached with the base, the stabilizing arm rests on the food item by gravity to stabilize the food item while cooking.

2. The apparatus of claim 1 wherein the enclosure is transparent.

3. The apparatus of claim 1 wherein the stabilizing arm includes an enlarged foot at a lower end thereof adapted for pressing the food item against the base.

4. The apparatus of claim 1 wherein the aperture of the enclosure and the stabilizing arm are each non-circular, such that the stabilizing arm cannot rotate when captured by the enclosure.

5. The apparatus of claim 3 wherein the stabilizing arm includes a knob at a top end thereof, both the knob and the enlarged foot of the stabilizing arm being larger than the aperture of the enclosure, such that the stabilizing arm is slidably captured by the enclosure.

6. The apparatus of claim 1 wherein the base includes a laterally-projecting handle portion.

7. The apparatus of claim 1 wherein the base and the enclosure each have a generally rectangular shape.

8. The apparatus of claim 1 wherein the base, the enclosure, and the stabilizing arm are each made from a microwave-safe plastic material.

9. The apparatus of claim 1 wherein the enclosure is selectively attachable with the base at an open lower end of the enclosure, the open lower end of the enclosure forming a friction-fit around a perimeter of a lip of the base.

10. An apparatus for stabilizing at least one food item, comprising:
a base having a top, substantially horizontal platform surface and an enclosure retention means proximate a peripheral edge thereof,
a enclosure having an open lower end, a peripheral edge adapted to engage the enclosure retention means of the base; and
a stabilizing means fixed to the enclosure;
whereby with the at least one food item positioned on the base and with the enclosure engaged over the at least one food item to the base, the stabilizing means contacts at least one of the food items and applies a downward pressure thereto by gravity to keep the at least one food item from tipping during cooking.
